(19) United States
(12) Patent Application Publication
(10) Pub. No.: US 2008/0181555 A1
(43) Pub. Date: Jul. 31, 2008

(54) Well Bore Sensing

(76) Inventor: Philip Head, West Drayton (GB)

Correspondence Address: K.F. ROSS P.C., 5683 RIVERDALE AVENUE, SUITE 203 BOX 900, BRONX, NY, 10471-0900, US

(21) Appl. No.: 11/886,407

(22) PCT Filed: Mar. 16, 2006
(86) PCT No.: PCT/GB2006/050057

§ 371 Date: Sep. 13, 2007

(30) Foreign Application Priority Data
Mar. 16, 2005 (GB) 0505363.2
Jun. 1, 2005 (GB) 0511151.3
Jul. 12, 2005 (GB) 0514258.3
Sep. 7, 2005 (GB) 0518205.0
Sep. 8, 2005 (GB) 0518330.6
Feb. 2, 2006 (GB) 0602077.0

(51) Int. Cl. G02B 6/34

(52) U.S. Cl. 385/13

(57) ABSTRACT

A sensor system for use in a well bore includes a metal-clad fibre-optic cable, the fibre optic cable include one or more Bragg gratings, and each Bragg grating is configured such that a value or change in a physical parameter to be measured results in a measurable value or change in the Bragg grating. The sensor system is included in a tool moveable through a drill string. The Bragg gratings are subjected to a strain related to the well bore's pressure, such that the pressure can be determined from the characteristics of the Bragg grating.

The present invention relates to well bore sensing, that is, using sensors to measure physical parameters of a well bore.

There are many different parameters which one may wish to measure in a well, some associated with the general well environment, and others relating to particular stages in the completion and production of the well, and even to particular procedures carrying out in the well.

Particular instances where it is desired to measure conditions include production testing of wells, which is a well established practice to understand which zones are in production and what they are producing from a well. Another example is is the monitoring of changes in the internal diameter of a flow path in an oil well casing which may be subject to reduction in diameter through deposition of scale, or through formation collapse, or to an increase in diameter caused by corrosion or mechanical damage.

Other instances of well sensing occur when it is desired to monitor the performance of a particular tool or part of a tool. For example, during gas lift of a well (where gas is used to help lift hydrocarbons from reservoir to surface), gas is injected under pressure from the surface into the production tubing annulus. Down the length of the production tubing are located gas lift valves. Each are set to a pre defined cracking pressure, so that they meter gas into the production tubing, which in turn helps to lift the oil to surface. If a valve is not working correctly or is not allowing sufficient gas to enter the production tubing, then production is not optimised and the net flow rate is not maximised.

Conventional tools used to perform these measurements typically require electrical power; for example, in measuring the flow rate, a flow diverter is used to direct the flow to the central area of the production tubing where a turbine flow meter is used to determine the combined flow at that point in the well.

It will be appreciated that any sensors and also require associated electronics, power supplies and associated hardware has to tolerate the harsh chemical, temperature and pressures subjected to at depth in an oil or gas well.

A common type of communications link includes a wireline in which one or more electrical conductors route power and data between a downhole component and the surface equipment. Other conveyance structures can also carry electrical conductors to enable power and data communications between a downhole component and surface equipment. To communicate over an electrical conductor, a downhole component typically includes electrical circuitry and sometimes power sources such as batteries. Such electrical circuitry and power sources are prone to failure for extended periods of time in the typically harsh environment (high temperature and pressure) that is present in a wellbore.

Another issue associated with running electrical conductors in a wireline, or other type of conveyance structure, is that in many cases the wireline extends a an intervention, remedial, or investigative tool into a wellbore. Conventionally, such intervention, remedial, or investigative tools are carried by a wireline, slickline, coiled tubing, or some other type of conveyance structure. If communication is desired between the intervention, remedial, or investigative tool and the surface equipment, electrical conductors are run through the conveyance structure. As noted above, electrical conductors are associated with various issues that may prove impractical in some applications.

It is an objective of this invention to eliminate the need for electrically powered sensors, and to allevaite the problems outlined above.

According to the present invention there is provided a sensor system for use in a well bore including a metal-clad fibre-optic cable, the fibre optic cable include one or more Bragg gratings, each Bragg grating being configured such that a value or change in a physical parameter to be measured results in a measurable value or change in the Bragg grating.

According to another aspect of the present invention, there is provided a sensor system for use in a well bore including a fibre-optic cable, the fibre optic cable include one or more Bragg gratings, each Bragg grating being configured such that a value or change in a physical parameter to be measured results in a measurable value or change in the Bragg grating.

According to another aspect of the present invention, there is provided a sensor system for use in a well bore including a fibre-optic cable, the fibre optic cable include one or more Bragg gratings, each Bragg grating being configured such that a value or change in a physical parameter to be measured results in a measurable value or change in the Bragg grating.

According to another aspect of the present invention, there is provided a sensor system for use in a well bore including a fibre-optic cable, the fibre optic cable include one or more Bragg gratings, each Bragg grating being configured such that a value or change in a physical parameter to be measured results in a measurable value or change in the Bragg grating, the Bragg gratings being suspended from the fibre-optic cable.

Bragg grating sensors can measure local strain, this can be used to determine, pressure, differential pressure, acceleration, temperature etc. By directing the fluid flow through a venturi, and measuring the pressure at the entrance and throat it is possible to deduce the flow rate. This eliminates electrically powered sensors yet can achieve all the measurements required up to temperatures at least as high as high as 300 C. Strain on the Bragg gratings may be induced mechanically, hydraulically, electrically, or magnetically.

Sensors for the measurement of various physical parameters such as pressure and temperature often rely on the transmission of strain from an elastic structure (e.g., a diaphragm, bellows, etc.) to a sensing element. In a pressure sensor, the sensing element may be bonded to the elastic structure with a suitable adhesive. An industrial process sensor is typically a transducer that responds to a measure and with a sensing element and converts the variable to a standardized transmission signal, e.g., an electrical or optical signal, that is a function of the measure and. Industrial process sensors utilize transducers that include pressure measurements of an industrial process such as that derived from slurries, liquids, vapors and gasses in refinery, chemical, pulp, petroleum, gas, pharmaceutical, food, and other fluid processing plants. Industrial process sensors are often placed in or near the process fluids, or in field applications. Often, these field applications are subject to harsh and varying environmental conditions that provide challenges for designers of such sensors. Typical electronic, or other, transducers of the prior art often cannot be placed in industrial process environments due to sensitivity to electromagnetic interference, radiation, heat, corrosion, fire, explosion or other environmental factors. It is also known that the attachment of the sensing element to the elastic structure can be a large source of error if the attachment is not highly stable. In the case of sensors that measure static or very slowly changing parameters, the long term stability of the attachment to the structure is extremely important. A major source of such long term sensor instability is a phenomenon known as “creep”, i.e., change in strain on the sensing element with no change in applied load on the elastic structure, which results in a DC shift or drift error in the sensor signal. Certain types of fiber optic sensors for measuring static and/or quasi-static parameters require a highly stable, very low creep attachment of the optical fiber to the elastic structure. Various techniques exist for attaching the fiber to the structure to minimize creep, such as adhesives, bonds, epoxy, cements and/or solders. However, such attachment techniques may exhibit creep and/or hysteresis over time and/or high temperatures. One example of a fiber optic based sensor is that described in U.S. Pat. No. 6,016,702 entitled “High Sensitivity Fiber Optic Pressure Sensor for Use in Harsh Environments” to Robert J. Maron, which is incorporated herein by reference in its entirety. In that case, an optical fiber is attached to a compressible bellows at one location along the fiber and to a rigid structure at a second location along the fiber with a Bragg grating embedded within the fiber between these two fiber attachment locations and with the grating being in tension. As the bellows is compressed due to an external pressure change, the tension on the fiber grating is reduced, which changes the wavelength of light reflected by the grating. If the attachment of the fiber to the structure is not stable, the fiber may move (or creep) relative to the structure it is attached to, and the aforementioned measurement inaccuracies occur. In another example, a optical fiber Bragg grating pressure sensor where the fiber is secured in tension to a glass bubble by a UV cement is discussed in Xu, M. G., Beiger, H., Dakein, J. P; “Fibre Grating Pressure Sensor With Enhanced Sensitivity Using A Glass-Bubble Housing”, Electronics Letters, 1996, V01 32, pp. 128-129. However, as discussed hereinbefore, such attachment techniques may exhibit creep and/or hysteresis over time and/or high temperatures, or may be difficult or costly to manufacture.

The invention will now be described, by way of example, with reference to the drawings, of which;

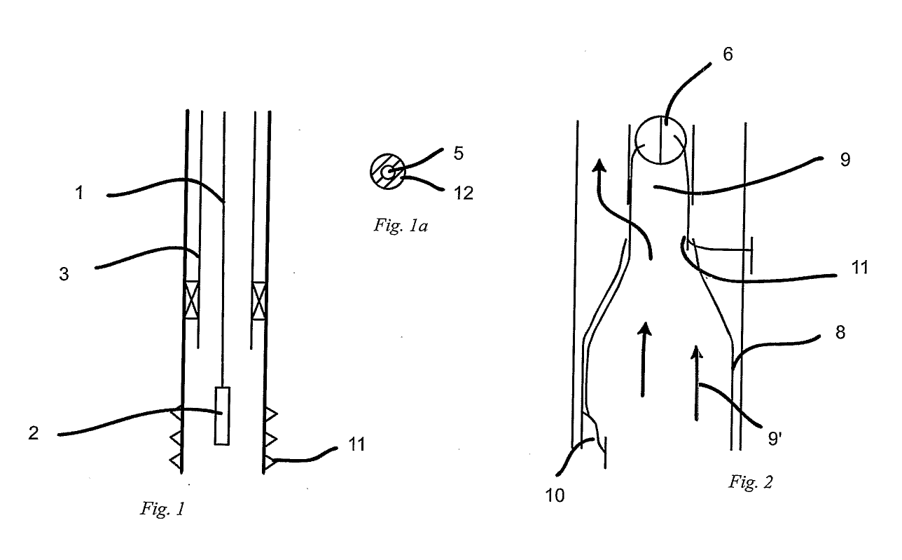

FIG. 1 is a side view of a tool, as deployed through the production tubing of a well;

FIG. 1a is a cross sectional view of the wireline upon which the tool is suspended;

FIG. 2 is a more detailed sectional side view of the tool shown in FIG. 1;

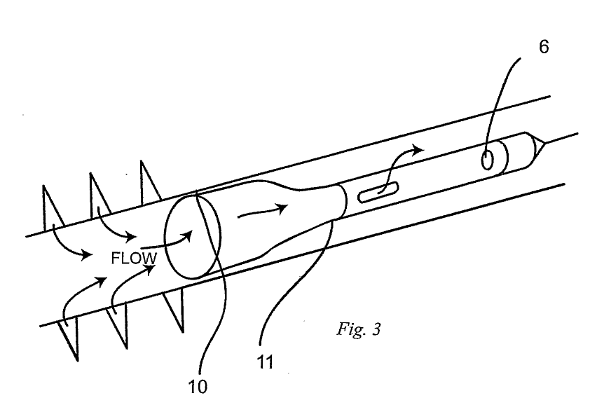

FIG. 3 is a perspective view of the assembly shown in FIG. 2;

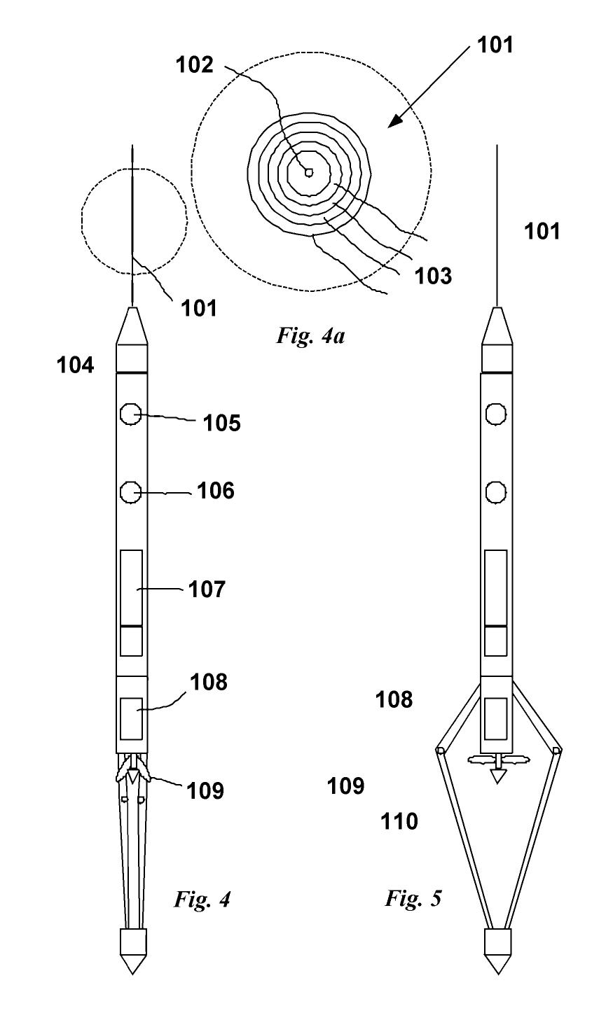

FIG. 4 is a side view of a typical production logging tool suspended on a slickline with fibre optic cable up its centre;

FIG. 4a is cross section of the slickline, and which shows the slickline multi layer construction;

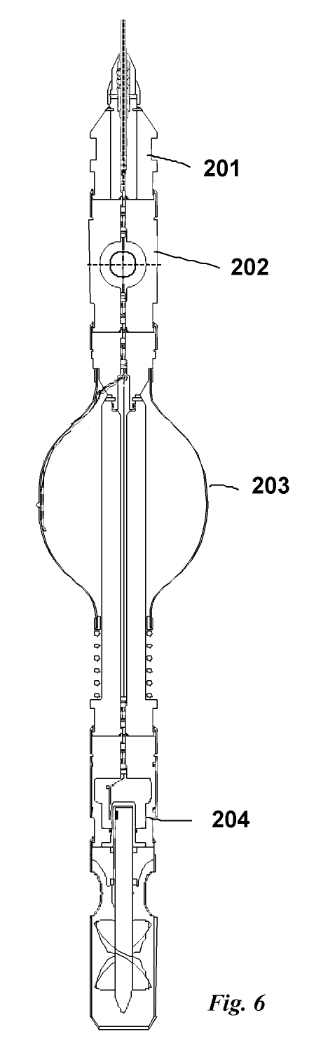

FIG. 5 shows the logging tool of FIG. 4 with its centraliser deployed and a turbine flowmeter in its open position;

FIG. 6 is a side view of another embodiment of a production logging tool;

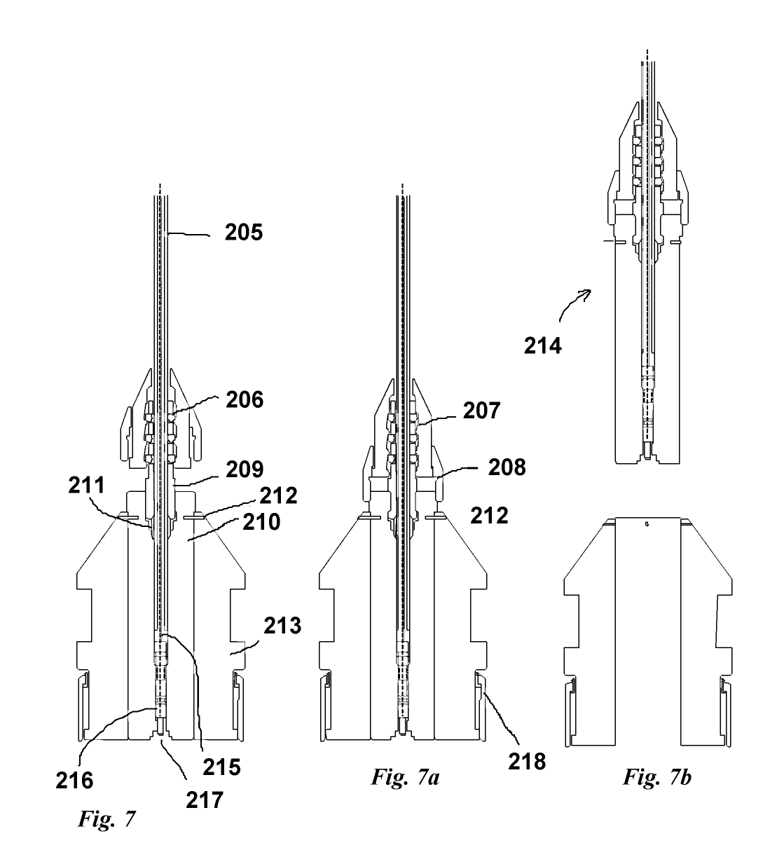

FIGS. 7, 7a and b are sectional views showing attachment of the tool to the slickline;

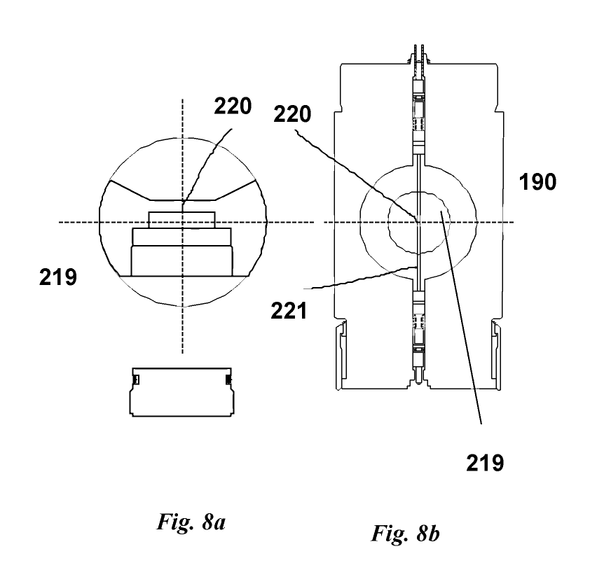

FIG. 8a and 8b are a cross sectional views of the of pressure and temperature sensors;

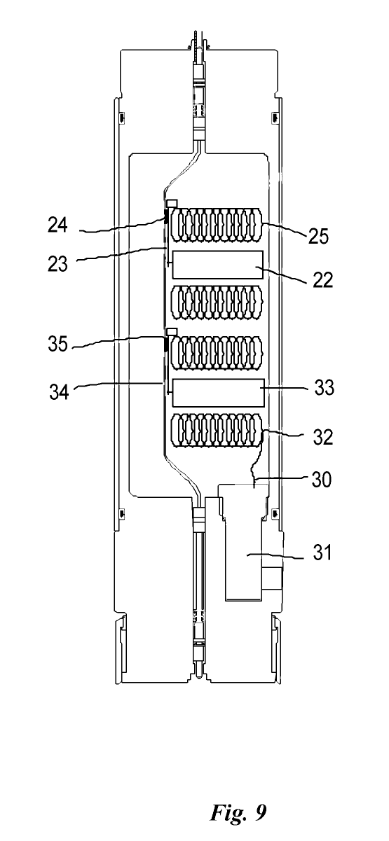

FIG. 9 is a sectional side view of another logging tool in which a battery operated gamma ray detector and casing collar locator are retained and via an interface pass processed information back onto the fibre optic cable via a Bragg grating;

FIG. 10 is a cross section of a mechanical casing collar locator (ccl) again a Bragg grating on the same fibre is used to transmit the information back to surface;

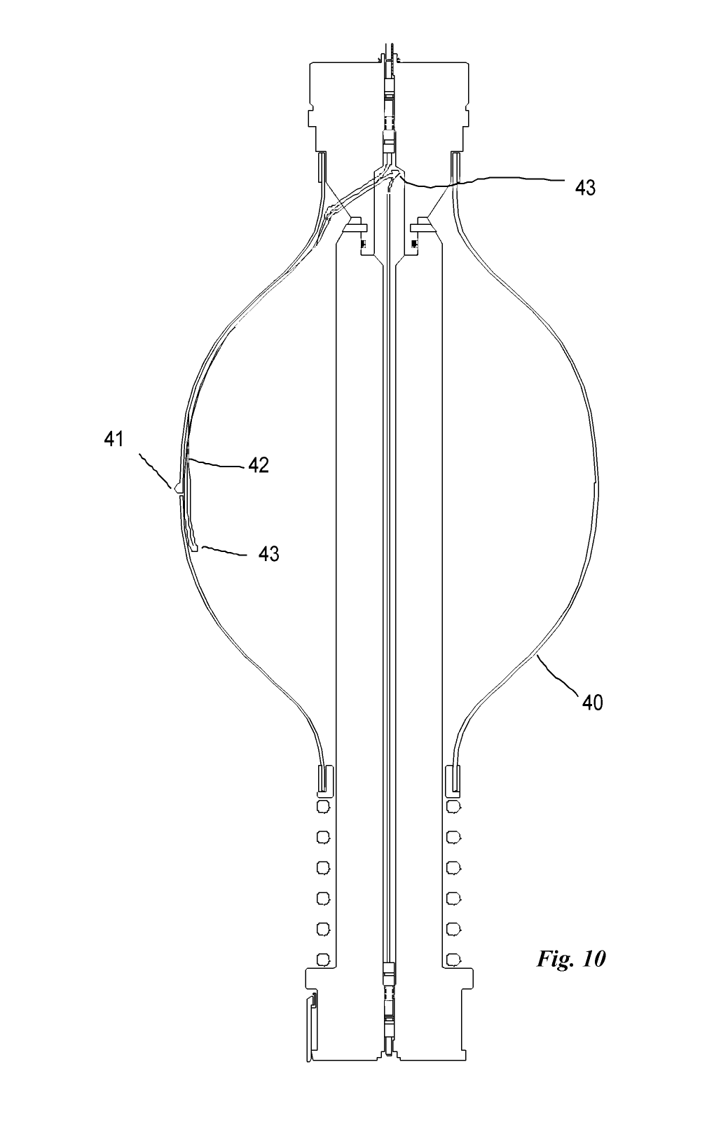

FIG. 11 is a sectional side view of a turbine flowmeter;

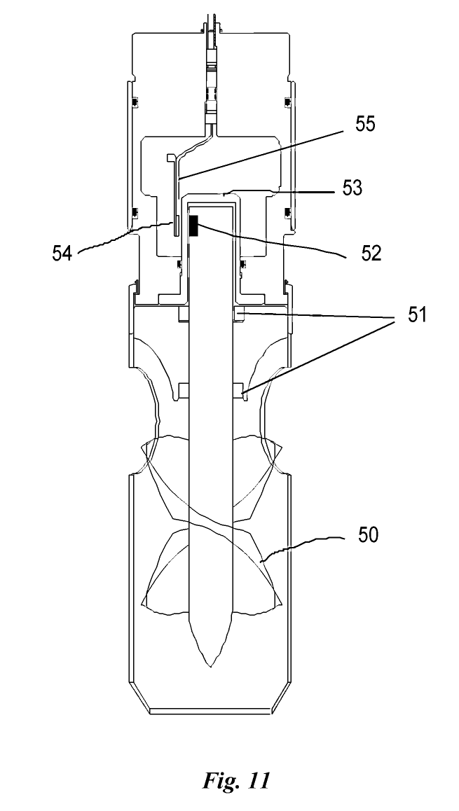

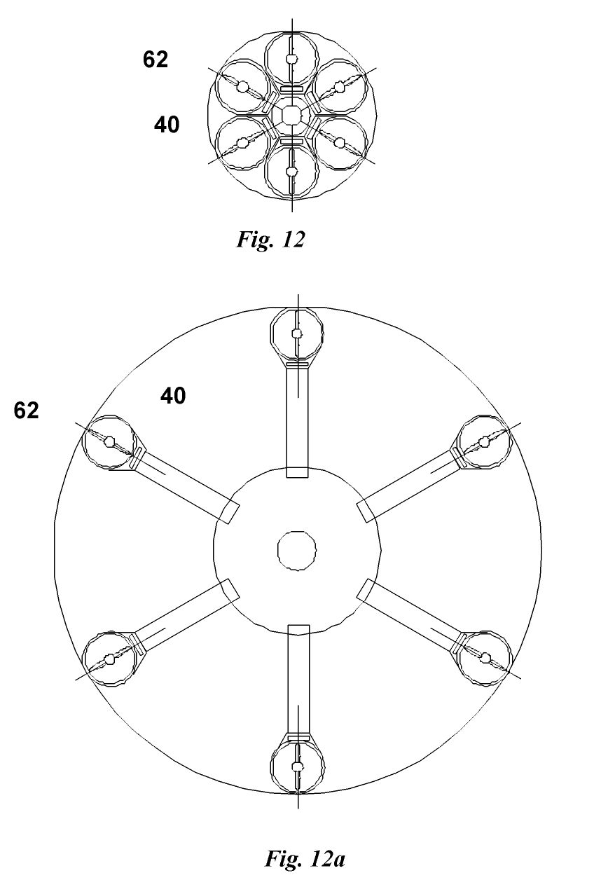

FIG. 12a and b are bottom elevation views of a multi turbine assembly;

FIG. 13a is a side section view of the flowmeter of FIG. 12;

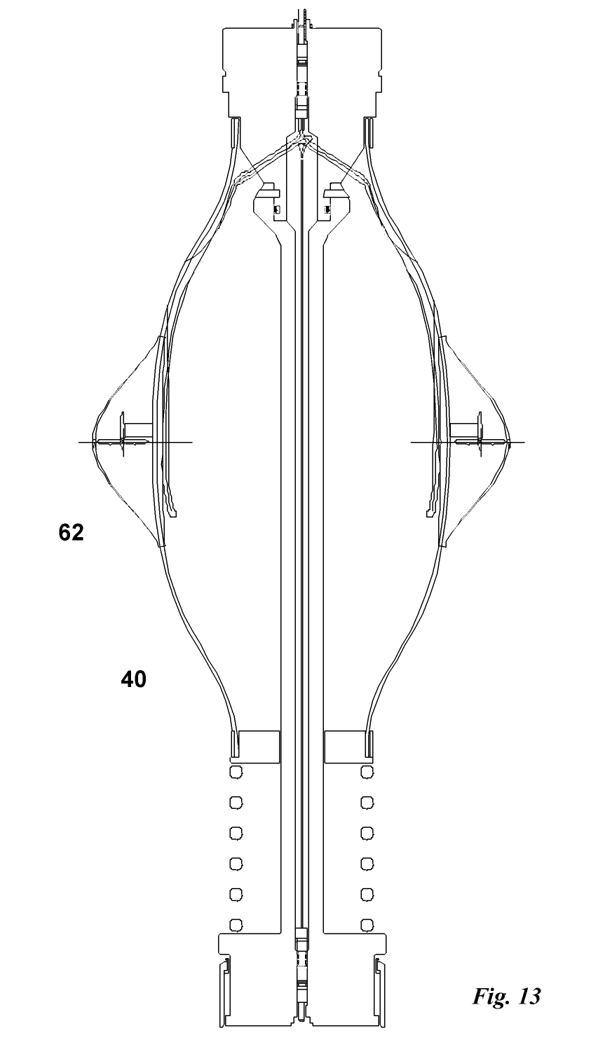

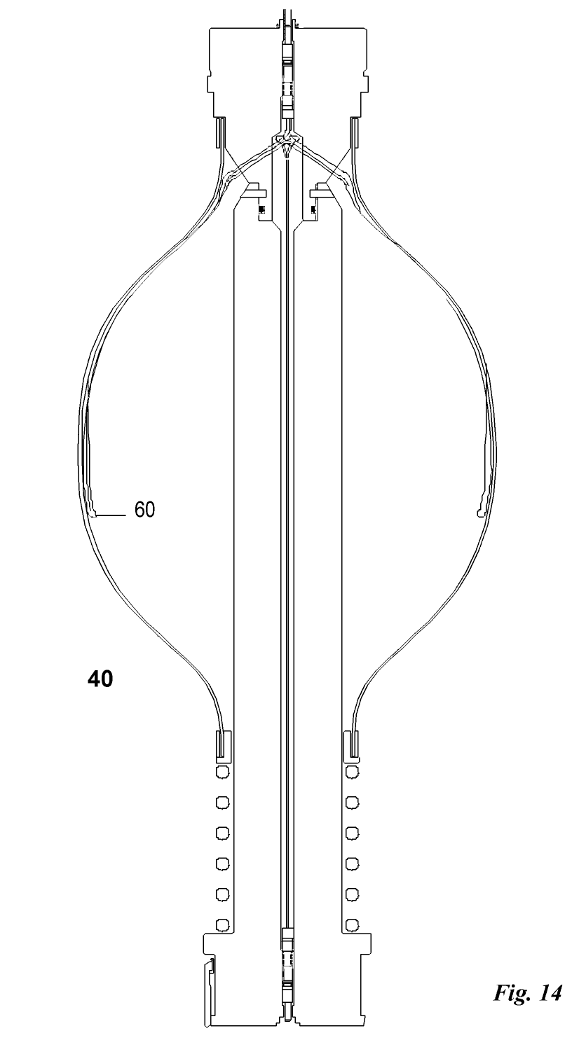

FIG. 14 shows a side view of another embodiment of a logging tool;

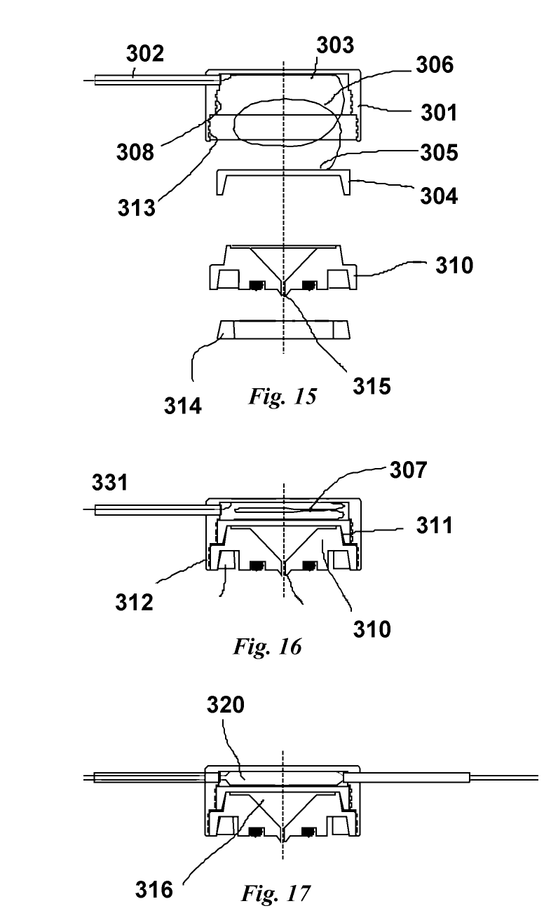

FIGS. 15 to 17 show a sectional side view of the fabrication of a sensor;

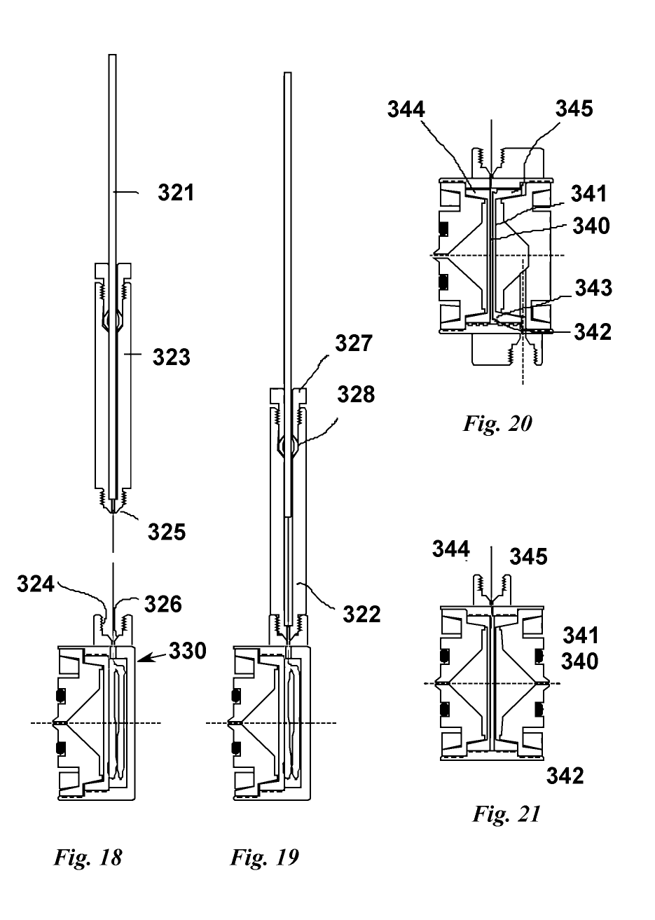

FIGS. 18 and 19 show a sectional side view of another embodiment of a sensor;

FIG. 20 shows a sectional side view of another embodiment of a sensor;

FIG. 21 shows a sectional side view of another embodiment of a sensor;

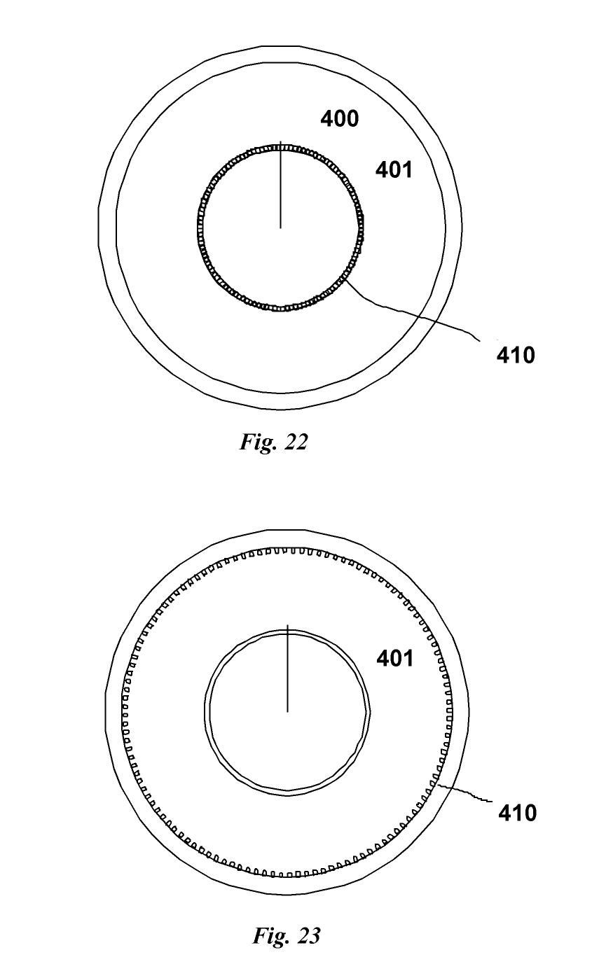

FIG. 22 is an end view of another tool (undeployed) inside a casing;

FIG. 23 is an end view of the tool (deployed) inside a casing;

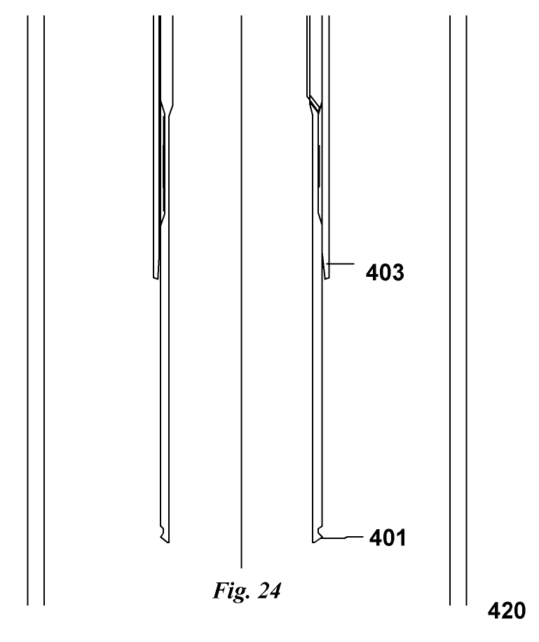

FIG. 24 is a side view of tool of FIG. 22;

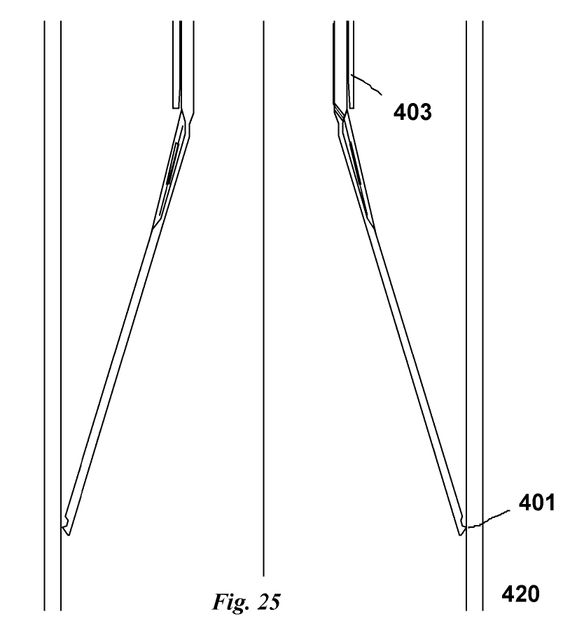

FIG. 25 is a side view of tool of FIG. 23;

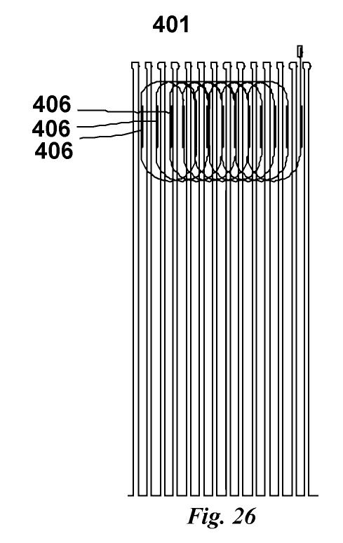

FIG. 26 is a sectional view of the fingers showing the fibre optic cable routing;

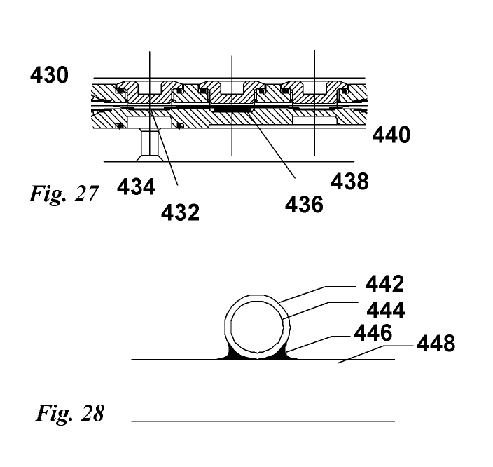

FIG. 27 is a sectional view of another embodiment of a series of sensors;

FIG. 28 is a cross sectional view of the attachment of the fibre-optic cable;

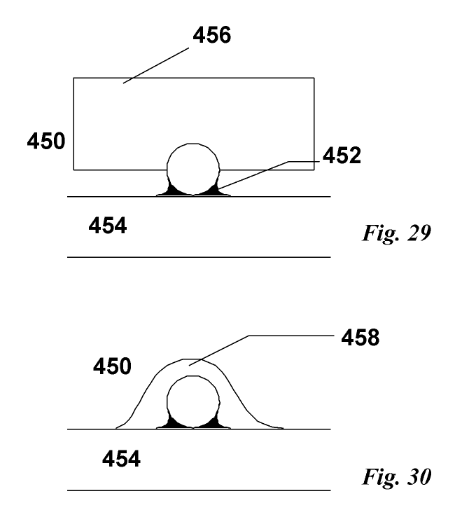

FIGS. 29 are cross sectional views showing another method of attachment of the fibre-optic cable.

Referring to FIG. 1, a slick line 1 (metal wire) is used to lower and raise a tool assembly 2 through production tubing 3 into the reservoir section of a well 4. The slick line comprises a central fibre optic cable 5 surrounded by a supporting layer 12 as shown in FIG. 1a, this fibre optic cable being used to monitor the condition of a series of Bragg grating fibre optic sensors 6. Referring to FIGS. 2 and 3, once the tool reaches the maximum depth in the well, it is moved upwards, and bow springs attached to the tool trigger a flow diverter 8 to deploy, which causes all the flow from the well to pass through the throat 9 of the flow diverter. Capillary tubes 10 and 11 located at the flow inlet 9′ and throat 9 of the flow diverter or venturi 12 are connected to a Bragg grating differential pressure sensor 6, the fibre optic cable from the surface interrogates this sensor and from this data can be derived the flow rate at that point in the well. The Bragg grating will be described described in more detail below, but is very much simpler than for example a wheatstone bridge type sensor.

Referring to FIG. 4, 4a and 5, there is shown the general arrangement for a further embodiment of a downhole production logging tool. The tool is lowered into the well on a multi-skinned slickline shown in FIG. 4a, where a fibre-optic cable is encased in multiple layers of supporting material such as steel. The slickline is constructed using thin wall sheet stainless steel 103 (or other suitable weldable material) which is formed around the fibre one layer at a time. Each layer is formed into a tube around the fibre from a strip of steel, and then laser welded along the seam so as to reduce the amount of heat that the fibre experiences. Heat shielding may also be used, particularly for the first layers. The tube is initially formed with an internal diameter larger than the outer diameter of the fibre (or the previous tube) that it is formed over, and then the tube is swaged down to a snug fit. It is easier to form several relatively thin layers into tubes and swage them to fit, than it is to do the same with a single piece of material of having the same total thickness. The use of several separate layers results in a line which is very strong with high tensile load carrying capability and has a small diameter.

Referring to FIG. 6, the slickline is attached to the toolstring using a connector 104 with suitable bend/stress reduction at the major anchoring point itself. Various sensors are incorporated, for example (but not limited to) a pressure and temperature sensor 105, casing collar locator 106, gamma ray 107, centraliser activation 108 and turbine flowmeter 109. Referring also to FIG. 7, when measurements are to be taken, particularly flow measurements, the centraliser activation 108 causes the centraliser 110 to expand, centralising the tool in the tubing, and activates the flow turbine 109.

Referring to FIG. 6, there is shown a production logging tool, built up of various sub assemblies. The sub assemblies are, a connector which secures the tool 201 to the slickline, 202 a pressure and temperature sensor, 203 a centraliser and mechanical casing collar locator tool, 204 a turbine flow meter assembly. Each of these tools will be described in more detail by the following figures.

FIGS. 7, 7a and 7b show a means of mechanical and optically terminating a small diameter metal clad fibre optic tube. The metal clad tube 205 is made up of several layer, so that to grip onto all of the layers and ensure all the layers carry the load, small balls 206 are used which provide low stress points of grip, these are energised by ramps 207, when the nut 208 is made tight. The balls are retained in a body 209, which when screwed into housing 210 energises a metal to metal seal 211 which seals the metal to metal tube 205 to the housing 210. The housing 210 is attached by a shear pin 212 to a standard connector body 213. In the event the tool string gets stuck, the slickline 205 can be overpulled and the shear pins 212 will fail and the assembly 214 can be recovered to surface. The fibre 215 inside the metal clad tube is fed into a precision fibre optic termination 216 which is retained in the bore of the housing 210. The excess fibre is cut and the face polished 217 to ensure minimum losses. A standard connection coupling 218 is fitted to the end of each coupling which enable the assemblies to be connected without turning the fibre optic connection.

FIG. 8a and 8b the pressure and temperature module and the pressure diaphragm 219. The fibre optic 190 cable contains two Bragg gratings 220 and 221, one which is attached to the centre of the pressure diaphragm 220, so when the diaphragm 219 is subjected to pressure the Bragg grating is strained and the a change in wavelength is measured. The fibre in the region of the second Bragg grating is not attached to anything but is free standing in the chamber and is only stained by temperature, and is used to correct temperature effects in the Bragg grating 220. If the fibre is polyamide coated the fibre is bonded to the diaphram using low viscosity high temperature adhesive, if the fibre is copper coated, it can be soldered to the diaphram, which increases its range of temperature operation significantly.

FIG. 9 shows the section side view through a housing. A sensitive coil 25 detects the changes in magnetic field as it passes the extra metal mass at a casing collar. This signal is amplified using a battery 21 and the signal is conveyed to the rod 22 in the coil core. This in turn moves a caterlever beam 23, onto which is attached a Bragg grating sensor 24. Strain changes in the Bragg grating sensor are measured from surface as changes in wavelength, from this casing collar locator (CCL) information can be derived. A scintillating chamber 30 detects gamma rays which measured using a photoelectric cell 31. The quantity or radiation count is converted to a electrical coil 32, which in turn moves a rod 33. This in turn moves a caterlever beam 34, onto which is attached a Bragg grating sensor 35. Strain changes in the Bragg grating sensor are measured from surface as changes in wavelength, from this a gramma ray plot can be generated.

FIG. 10 shows a mechanical version of a CCL. A bow spring centraliser 40 is used to keep the tool centred in the well. Each bow spring 40 is in intimate contact with the tubing and casing internal surface (not shown). At the centre of the bow spring is a canterlever 41 button which relaxes to its extended position when a coupling is crossed, this in tern changes the stain for a Bragg grating sensor 42 mounted on the canterlever beam 43. Low loss microbends are used to get the fibre around the mechanical assembly in the most optically efficient means.

Referring to FIG. 11 there is shown the side cross section for a turbine flow meter. An turbine 50 on an axial turbine shaft is supported on bearings 51. A permanent magnet 52 is fitted to the shaft. The sleeve 53 adjacent to the magnet is non-magnetic, and so the canterlever 54 reacts to the effect of the magnet passing by it. Attached to the canterlever beam is a Bragg grating sensor 55. With each rotation of the shaft, the cantilever beam 54 describes one cycle of moving towards and away from the shaft, causing strain changes in the Bragg grating sensor which are measured from surface as changes in wavelength. From this the revolutions of the turbine, and therefore the flow rate, can be derived.

Referring to FIGS. 12a and 12b and FIG. 13 miniature flow measuring turbines 62 may be attached to bow springs 40. This enables flow measurements to be made at specific circumferencial sections of the borehole. This would be beneficial in a horizontal well for example where the different phases become layered. i.e. gas on the top layer flowing faster than the oil and water phase on the bottom layer.

FIG. 14 shows a further embodiment of this invention, using fibre optic acoustic sensors 60 mounted on the bow springs 40 to record the response from a battery powered acoustic source (not shown) used for cement bond logging (CBL's). The acoustic sensors are in intimate contact with the casing (again, not here shown) and produce a picture of the cement bond behind the casing relative to the bow spring they are attached too. Clearly the more bow springs provided around the tool the better the picture generated. As in previous examples, this is a passive measurement and the data is transmitted back to surface via a dedicated fibre/acoustic sensor.

Referring to FIGS. 15 to 17 there is shown an absolute pressure and temperature sensor utilising Bragg grating fibre optics. A housing 301 has a hermetically sealed tube 302 attached to it by welding or other permanent bonding means. A fibre optic cable 331 which includes two Bragg grating sensing elements is fed into the tube 302 and one Bragg brating element is bonded to the outer surface of the housing 303 and the other is bonded 305to the pressure sensitive dish 304, the fibre being allowed to follow a helical path 306, so that when the sensor is assembled no unnecessary stress is produced in the fibre. The pressure sensitive disc sits in a bore 308, which has concentric undercuts machined into it. A process interface sleeve 310 has an interferance fit at the interface 311. This swages the pressure sensitive disc against the concentric undercuts 308 and forms many metal to metal seals. The process interface sleeve 310 is located in a similar bore 312 to the pressure sensitive disc. And this is swaged into the concentric undercuts 313 using a ring 314. On the outer surface of the process connection is a conventional autoclave type metal to metal process fitting 315, which also allows the process fluid into the metal to metal sealed pressure sensing chamber 316. In the atmospheric chamber 320, one Bragg grating sensor 303 provides a reference strain for ambient conditions, and the Bragg grating sensor 307 attached to the pressure sensing disc 304 has strain for ambient conditions together with the applied pressure. If the reference stain is deducted from the combined strains measured by the Bragg grating sensor 307, then a true measure of absolute pressure can be determined.

Referring to FIGS. 18 and 19, it maybe necessary to connect a single pressure sensor module 330 to a metal clad fibre 321. First two ends of the fibre are aligned and fused together using a fibre optic splicing tool (not shown, but well known in the art). Once fused together, minimum stress should be applied to this joint 322. A sleeve 323 is placed over the outside of the metal clad cable 321. This can be slid down the outside of the metal clad fibre 321 and threaded into a bore 324 on the sensor 330. On the tip of the sleeve is an autoclave type profile 325 which forms a metal to metal seal with a corresponding profile 326 when fully installed in the bore 324. Once secure in the bore 324 the outer nut 327 of the sleeve is tightened against a metal to metal seal olive 328. Thus the whole Bragg grating pressure sensor 330 is sealed in a metal to metal assembly.

Referring to FIGS. 20 and 21 there is shown two embodiments of a differential pressure sensor. In this design, the Bragg grating sensor 340 is bonded to one pressure sensing disc 341, the fibre continues to the edge of the disc where it is wrapped circumferentially in a small annular void 342, and in this void a further Bragg grating sensor element 343 is also located. The space between the two discs 344 and 345 is filled under vacuum with a suitable elastic potting/bonding material. The discs 344 and 345 are retained using the same process as for the embodiments described in FIGS. 15 to 19.

Referring FIGS. 22 to 26, a sensing tool includes a beryllium copper tube 410 (or a tube of some other springy material) has several slots 400 laser cut in one end. Each solid element 401 that remains after cutting the slots becomes a sensor finger. The fingers 401 are deformed using an expansion mandrel (not shown) until they are set to their maximum measuring diameter shown in FIG. 23. The tube 41.0 is then heat treated to initiate the spring properties of the material.

Referring to FIG. 24, when the tool is deployed in a casing or production tube 420 a sleeve 403 holds the spring fingers 401 in an undeployed position. When at the required position in the well, the sleeve 403 is retracted from the fingers 401 as shown in FIG. 25, so that the fingers deploy either to there maximum diameter or until they contact the internal surface of the casing 405 they are to measure.

A series of Bragg grating fibre optic sensors 406 are bonded to each finger at their bending point. The fibre has a limited bend radius, so each time the fibre is bent back on itself it misses out several fingers 401, this is repeated around the entire tube, until each the fibre is bonded to each finger.

Each Bragg grating sensor operates at a discrete wave length and so on a single fibre each grating can be individually interrogated to determine its strain and hence its angular deformation and corresponding diameter. One fibre can typically measure up to 128 sensors.

Referring to FIG. 27, a Bragg grating fibre 430 includes a first Bragg grating bonded to a first pressure diaphram 432 in contact with one region of the well via a port 434, before a second Bragg grating in the fibre is bonded to a piece of aluminium 436, and finally a third Bragg grating is bonded to a second pressure diaphram 438 in contact with a second region of the well via a second port 440 in order to provide a differential pressure value as previously described. The piece of aluminium quickly follows any change in ambient temperature, so the second Bragg grating provides a value by which changes in the readings of the first and third Bragg gratings which are due to temperature rather than changes in pressure can be compensated for. It will be seen that in this embodiment the path of the fibre is approximately linear as it passes through each sensor and on to the next, as opposed to sensor shown in FIG. 15 to 17 where the fibre is coiled so as to enter and exit through the sensor's single opening. By no coiling or bending the fibre, this embodiment puts less strain on the fibre.

Referring to FIG. 28, the glass fibre 442 which includes the Bragg gratings is clad in a layer of copper 444, and may be bonded to the pressure diaphram, piece of aluminium, iconel or other element 448, by high temperature solder 446. Alternatively, a fibre optic cable 450 may be coated in polyamide, as shown in FIGS. 29 and 30. A cable 450 is affixed to the pressure diaphram or other element 454 with high temperature low viscosity epoxy resin 452. Whilst the epoxy adhesive sets a weight 456 applies a uniform pressure to the cable 450. Finally, a layer of polyamide 458 is applied so as to cover the fibre optic cable 450.

1. A sensor system for use in a well bore including a metal-clad fiber-optic cable, the fiber optic cable include one or more Bragg gratings, each Bragg grating being configured such that a value or change in a physical parameter to be measured results in a measurable value or change in the Bragg grating.

2. The sensor system according to claim 1 wherein the sensor system is included in a tool moveable through a drill string.

3. The sensor system according to claim 1 wherein at least one of the Bragg gratings is subjected to a strain related to the well bore's pressure, such that the pressure can be determined from the characteristics of the Bragg grating.

4. The sensor system according to claim 3 wherein two such gratings measuring pressure are included with a venturi, each grating measure the pressure at a different position such that the fluid flow rate in a well bore can be determined.

5. The sensor system according to claim 1 wherein the fiber-optic cable is incorporated in a wireline leading to the surface.

6. The sensor system according to claim 5, wherein the fiber-optic cable is incorporated into the cable suspending the tool.

7-15. (canceled)

16. The sensor system according to claim 1 wherein a tool includes a member that contacts the inner surface of the well bore or a tube in a well bore, the tool including a Bragg grating whose strain is related to the position of the member such that the diameter of the well bore or tube can be measured.

17. The sensor system according to claim 1, further comprising a flowmeter that produces a strain on one of the Bragg gratings related to the rate of flow.

18. The sensor system according to claim 1 wherein a tool includes a member that contacts the inner surface of the well bore or a tube in a well bore, the tool including a Bragg grating whose strain is related to the position of the member such s that the diameter of the well bore or tube can be measured.

19. The sensor system according to claim 1 wherein there is included a flowmeter that produces a strain on one of the Bragg gratings related to the rate of flow.

20. The sensor system for use in a well bore including a fiber-optic cable having one or more Bragg gratings, each Bragg grating being configured such that a value or change in a physical parameter to be measured results in a measurable value or change in the Bragg grating.

21. The sensor system defined in claim 20 wherein the Bragg grating is suspended from the fiber-optic cable.
